(19) United States
(12) Patent Application Publication
(10) Pub. No.: US 2025/0060128 A1
(43) Pub. Date: Feb. 20, 2025

(54) PTC WATER HEATER WITH MODULAR FASTENING AND HEATING COMPONENTS

(71) Applicant: Dongguan Sharing Electronics Co., Ltd., Dongguan City (CN)

(72) Inventors: Xiang Wu, Shenzhen City (CN); Juntao Wen, Shenzhen City (CN); Xingang E, Dongguan City (CN)

(21) Appl. No.: 18/419,975

(22) Filed: Jan. 23, 2024

(30) Foreign Application Priority Data
Aug. 18, 2023 (CN) 202322242658.0

(51) Int. Cl. F24H 1/18; H05B 3/06; H05B 3/28

(52) U.S. Cl. CPC F24H 1/185; H05B 3/06; H05B 3/286; F24H 2250/04; H05B 2203/02

(57) ABSTRACT

Provided is a PTC heater with modular fastening and heating components, which comprises a copper electrode plate, a PTC ceramic plate, a thermally conductive silicone part, and a U-shaped fastening aluminum part, wherein the thermally conductive silicone part is arranged in the U-shaped fastening aluminum part and conforms to the fastening aluminum part, wherein the PTC ceramic plate is placed inside the thermally conductive silicone part, and wherein the copper electrode plate is positioned on a side of the PTC ceramic plate and inside the thermally conductive silicone part. The PTC heater is simple and facilitates modularization, and the external U-shaped fastening aluminum part can be fastened to the water tank, thereby meeting automation requirements. The components of PTC heater can be securely fastened by one-way pressing, facilitating convenient production and ensuring stable electrical power.

### CROSS-REFERENCE TO RELATED APPLICATIONS

This application claims priority to Chinese Patent Application No. 202322242658.0, filed on Aug. 18, 2023. The disclosure of the application is incorporated herein for all purposes by reference in its entirety.

### TECHNICAL FIELD

The present disclosure relates to the technical field of positive temperature coefficient (PTC) heaters, and particularly relates to a PTC water heater with modular fastening and heating components.

### BACKGROUND

PTC (water) heater is commonly used in vehicle air conditioning units. The existing PTC water heater forms as a metal casing housing a layer of PTC heating elements, and the PTC heating elements are connected to an external power source via a power cord. When in use, this single-layer PTC water heater is placed into water to be heated and powered on for heating the water. However, the PTC water heater of such structure has the following drawbacks: lower heating efficiency, inaccurate positioning, unstable power output, and difficulty in achieving automated production.

To date, no effective solutions have been proposed to address the issues present in the related prior art.

### SUMMARY

To overcome the technical issues present in the related prior art, the present disclosure provides a PTC water heater with modular fastening and heating components.

To achieve this, the specific technical solution adopted in the present disclosure is as follows:

A PTC heater with modular fastening and heating components, comprising a copper electrode plate, a PTC ceramic plate, a thermally conductive silicone part, and a U-shaped fastening aluminum part, wherein the thermally conductive silicone part is arranged in the U-shaped fastening aluminum part and adapts to a shape of the fastening aluminum part, wherein the PTC ceramic plate is placed inside the thermally conductive silicone part, and wherein the copper electrode plate is positioned on a side of the PTC ceramic plate and is arranged inside the thermally conductive silicone part.

According to one or more embodiments, the U-shaped fastening aluminum part is fastened to a water tank.

According to one or more embodiments, the U-shaped fastening aluminum part is provided with symmetrical bending portions on a side.

The beneficial effects of the present disclosure are as follows:

The device is simple and facilitates modularization, and the external U-shaped fastening aluminum part can be fastened to the water tank, thereby meeting automation requirements; by means of the copper electrode plate connected to a power source, the device can efficiently convert electrical energy into thermal energy, ensuring reliable performance. Furthermore, the components of the device can be securely fastened by one-way pressing, facilitating convenient production and ensuring stable electrical power.

### BRIEF DESCRIPTION OF THE DRAWINGS

To enhance the clarity of the embodiments disclosed herein, a brief introduction to the accompanying drawings required for the embodiments is presented below. It is evident that the drawings described below represent only a subset of embodiments for the present disclosure. Those skilled in the art can derive additional drawings based on these illustrations without the need for additional creative effort.

FIG. 1 illustrates a schematic structural diagram of a PTC heater with modular fastening and heating components according to an embodiment in the present disclosure.

FIG. 2 illustrates an exploded view of the PTC heater with modular fastening and heating components in FIG. 1.

FIG. 3 illustrates the PTC heater with modular fastening and heating components, which is mounted to a water tank.

### REFERENCE LIST

1 copper electrode plate
2 PTC ceramic plate
3 thermally conductive silicone part
4 U-shaped fastening aluminum part
5 bending portion
6 water tank

### DETAILED DESCRIPTION

To provide a more comprehensive understanding of the various embodiments, accompanying drawings are included as an integral part of this disclosure. These drawings serve to elucidate the embodiments, and when coupled with the pertinent descriptions herein, help to clarify the operational principles of these embodiments. Through a thorough review of these drawings and associated explanations, those skilled in the art should be able to obtain alternative embodiments and appreciate the advantages of the disclosed subject matter. It is important to note that the components depicted in the drawings are not necessarily drawn to scale, and similar symbols are conventionally used to represent analogous components.

Various embodiments in the present disclosure provide a PTC water heater with modular fastening and heating components.

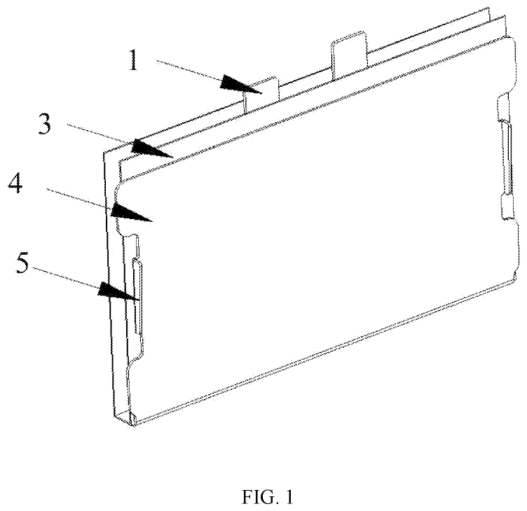

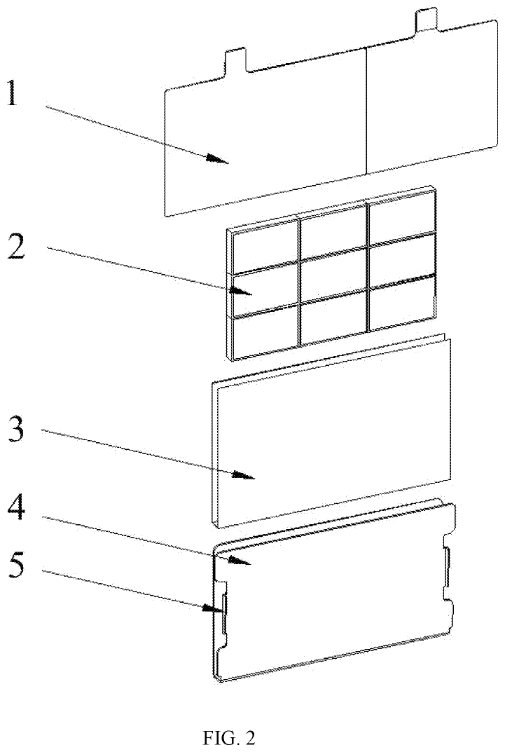

As shown in FIGS. 1-2, the PTC heater with modular fastening and heating components comprises a copper electrode plate 1, a PTC ceramic plate 2, a thermally conductive silicone part 3, and a U-shaped fastening aluminum part 4. The thermally conductive silicone part 3 is arranged in the U-shaped fastening aluminum part 4, and conforms to the shape of the fastening aluminum part 4, and the PTC ceramic plate 2 is placed inside the thermally conductive silicone part 3. The copper electrode plate 1 is positioned on a side of the PTC ceramic plate 2 and is arranged inside the thermally conductive silicone part 3.

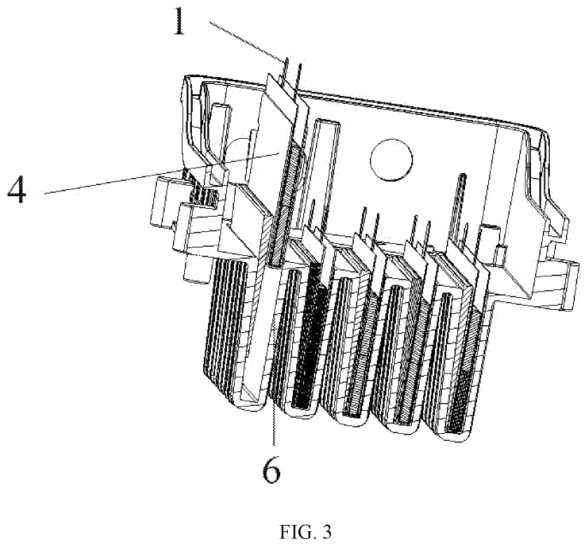

As shown in FIGS. 1-3, the U-shaped fastening aluminum part 4 can be fastened to a water tank 6, and the U-shaped fastening aluminum part 4 is provided with symmetrical bending portions 5 on one side, the bending portions 5 are configured to fix the U-shaped fastening aluminum part 4 to the water tank 6 after bending.

By virtue of the above technical solutions provided herein, the device is simple and facilitates modularization, and the external U-shaped fastening aluminum part can be fastened to the water tank, thereby meeting automation requirements; by means of the copper electrode plate connected to a power source, the device can efficiently convert electrical energy into thermal energy, ensuring reliable performance. Furthermore, the components of the device can be securely fastened by one-way pressing, facilitating convenient production and ensuring stable electrical power.

The above merely describes specific embodiments of the present disclosure, which is not intended to limit the scope of protection of the present disclosure. Any modifications, equivalent variations or substitutions, and improvements made within the spirit and principle of the present disclosure by those skilled in the art according to the disclosed technical scope should be included in the protection scope of the present disclosure.

1. A PTC heater with modular fastening and heating components, comprising a copper electrode plate, a PTC ceramic plate, a thermally conductive silicone part, and a U-shaped fastening aluminum part, wherein the thermally conductive silicone part is arranged in the U-shaped fastening aluminum part and are suitable for the fastening aluminum part, wherein the PTC ceramic plate is placed inside the thermally conductive silicone part, and wherein the copper electrode plate is positioned on a side of the PTC ceramic plate and is arranged inside the thermally conductive silicone part.

2. The PTC heater according to claim 1, wherein the U-shaped fastening aluminum part is fastened to a water tank.

3. The PTC heater according to claim 1, wherein the U-shaped fastening aluminum part is provided with symmetrical bending portions on a side.
